(19) United States
(12) Patent Application Publication
(10) Pub. No.: US 2010/0293471 A1
(43) Pub. Date: Nov. 18, 2010

(54) APPARATUS AND METHOD OF DIAGRAMMATICALLY PRESENTING DIVERSE DATA USING A MULTIPLE LAYER APPROACH

(75) Inventor: Richard James Lahti, Flower Mound, TX (US)

Correspondence Address: VERIZON;PATENT MANAGEMENT GROUP, 1320 North Court House Road, 9th Floor, ARLINGTON, VA, 22201-2909, US

(73) Assignee: VERIZON PATENT AND LICENSING INC., Basking Ridge, NJ (US)

(21) Appl. No.: 12/466,959

(22) Filed: May 15, 2009

(51) Int. Cl. G06F 3/01; G06F 15/173

(52) U.S. Cl. 715/734; 709/223

(57) ABSTRACT

An approach for compiling and diagrammatically presenting diverse data in a unified manner is provided. A method is provided that includes gathering information regarding assets used to provide a service to a customer over a network, and gathering information regarding services provided to the customer using the assets via the network. The method further includes generating a diagram having multiple layers including a first layer representative of the assets, a second layer containing information regarding connections of the assets to the network, and a third layer containing information regarding provisioning of the assets to provide the services to the customer.

### BACKGROUND OF THE INVENTION

Modern communication and multimedia service provides utilize complex networks to provide services to customers using a vast number of assets interconnected in a complex manner. Planning, installation, provisioning, and maintenance of the components of such networks that are needed to provide services to customers can be a daunting task involving a number of different departments/groups of technicians of the service provider.

For example, in order to provide services to a particular customer or a multiplicity of customers, the service provider may require installation and maintenance of a facility that can have a variety of computer components that are interconnected and housed within numerous computer cabinets, and that facility can be connected to one or more different network facilities. The service provider must provision the components in order to provide the necessary services to the various customers that receive services through the facility. Typically, the data regarding components at the facility may be documented in one or more different diagrams, and the data regarding network interconnections may be documented in a different format and in different diagrams. Also, the various groups of technicians of the service provide may maintain different notes regarding the components or services provided to various customers. As a result, the data relating to a particular customer or facility may be spread out amongst a vast number of documents that are cumbersome to review and difficult to use to assess the overall system layout.

Based on the foregoing, there is a need for compiling and presenting diverse data in a unified manner.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a multilayered diagram of infrastructure for and services provided to a customer network facility, according to various embodiments;

FIG. 2 is a diagram of various groups that aid in the compilation and maintenance of customer network facility records, according to various embodiments;

FIG. 3 is a detailed multilayered diagram of infrastructure for and services provided to a customer network facility, according to one embodiment;

FIG. 4 is a secondary notation sheet of the detailed multilayered diagram of FIG. 3, according to one embodiment;

FIGS. 5A-5D are screen-shots of a computer application used to generate a detailed multilayered diagram, including partial, enlarged views of an exemplary embodiment of a detailed multilayered diagram of infrastructure for and services provided to a customer network facility;

FIGS. 6A-6C are screen-shots of a computer application used to generate a detailed multilayered diagram, including partial, enlarged views of an exemplary embodiment of a secondary notation sheet of the detailed multilayered diagram of FIGS. 5A-5D; and

FIG. 7 is a diagram of a computer system that can be used to implement an embodiment of the present invention.

### DESCRIPTION OF THE PREFERRED EMBODIMENT

An apparatus, method, and software of diagrammatically presenting diverse data using a multiple layer approach are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

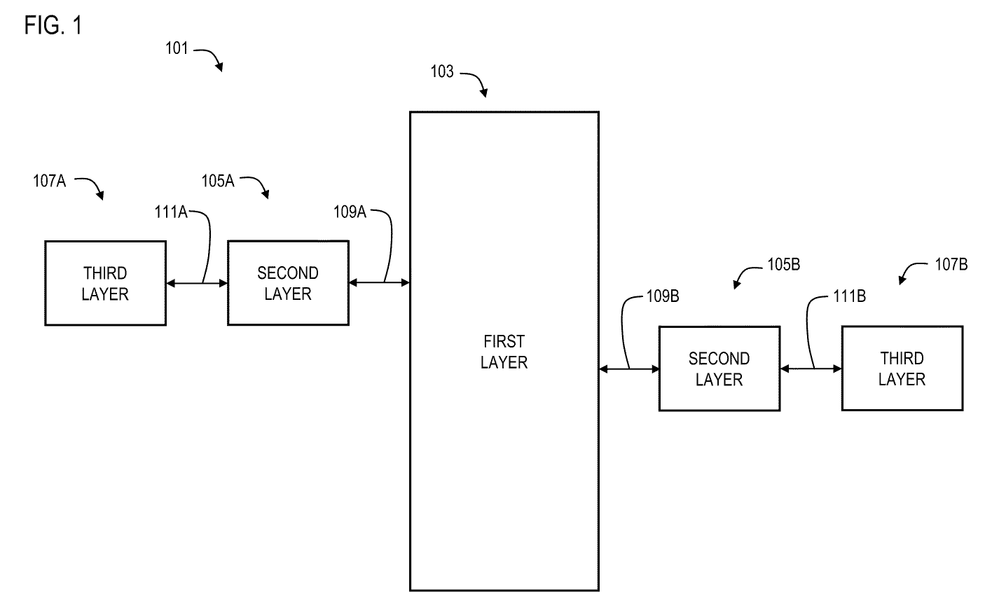

FIG. 1 is a multilayered diagram 101 of infrastructure for and services provided to a customer network facility, according to various embodiments. The diagram depicted in FIG. 1 includes three different main layers of data, as well as various interspersed data and notations, which are referred to herein as sub-layers, provided between the main layers. In this example, the three main layers include a first layer 103, a pair of second layers 105A and 105B, and a pair of third layers 107A and 107B. As can be seen in FIG. 1, the second and third layers are split such that they extending outwardly from the first layer 103 in left and right directions in order to maximize the utilization of the space on the diagram. Thus, second layer 105A extends in a leftward direction from the first layer 103 and third layer 107A extends in a leftward direction from the second layer 105A, and second layer 105B extends in a rightward direction from the first layer 103 and third layer 107B extends in a rightward direction from the second layer 105B.

Additionally, the multilayered diagram 101 includes several sub-layers that can be used to provide details or notations regarding the interconnections and/or services between the various main layers. For example, first sub-layers 109A and 109B are provided in between the first main layer 103 and the second layers 105A and 105B, respectively. Further, second sub-layers 111A and 111B are provided in between the second main layers 105A and 105B and the third layers 107A and 107B, respectively. Furthermore, other areas can be provided on the diagram for including various notations and details regarding the customer network facility.

The diagram described herein provides simplicity in workflow structure, where any technology can be represented within the design. In the exemplary embodiments described below, the diagram advantageously reflects not only equipment needs, but also incorporates service needs. While the exemplary embodiments described herein relate to customer (or subscriber) network facilities including equipment thereof and services provided thereto, the methods and systems described herein can also be utilized with other technologies and businesses, as will be readily apparent to one of ordinary skill in the art from the disclosure set forth herein. For example, the diagram can be used to serve any business that uses technology as its structure, and sells services to customers.

By way of illustration, the exemplary multilayered diagram described below pertains to common language location identifier (CLLI) code drawings. This identifier is an industry approach that provides information on location and type of equipment. The multilayered diagram, in one embodiment, is a simplified three-layer block diagram that captures the basic knowledge from multiple groups that work as a team to provide service to customers. For example, the multilayered diagram can compile information from various groups within the service provider, such as an engineering group, an installation group, and a service-provisioning group, which each contribute to and utilize the knowledge data provided in the drawing. The multilayered diagram advantageously provides a concise record of the knowledge gained from service port cabling to a site-specific demarcation. The diagram is organized to capture text notes of equipment design and general knowledge discovered from a specific building site.

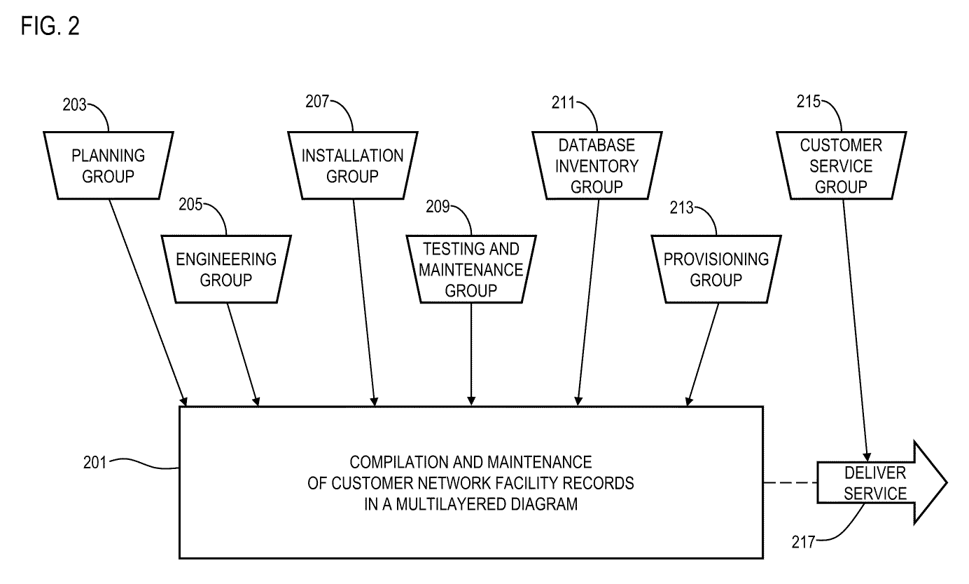

FIG. 2 is a diagram of various groups that aid in the compilation and maintenance of customer network facility records in a multilayered diagram, according to various embodiments. As depicted in FIG. 2, data from various groups is combined to form a compilation and to maintain the compilation of customer network facility records in the multilayered diagram, as represented by box 201. Thus, data from a planning group 203 (e.g., which provides the overall network design), an engineering group 205 (e.g., which provides for the equipment to implement the design), an installation group 207 (e.g., which installs and connects the equipment), a testing and maintenance group 209 (e.g., which performs tests and provides maintenance to the network), a database inventory group 211 (e.g., which maintains an inventory of the available assets), and a provisioning group 213 (e.g., which provisions the assets according to quality of service and service level agreements) can each be used to compile and maintain the multilayered diagram. Each of these groups can not only aid in the compilation and maintenance of the diagram, but can also benefit from and utilize the knowledge contained in the diagram, for example, from the data provided by other groups or others within their group. Additionally, the resulting multilayered diagram will allow a customer service group 215 to deliver service 217 to the customer(s) in an efficient and accurate manner. Additionally, as described in greater detail below, the multilayered diagram can also provide the added benefit of acting as a disaster recovery plan, by retaining the structural and service related information regarding a particular facility and/or customer.

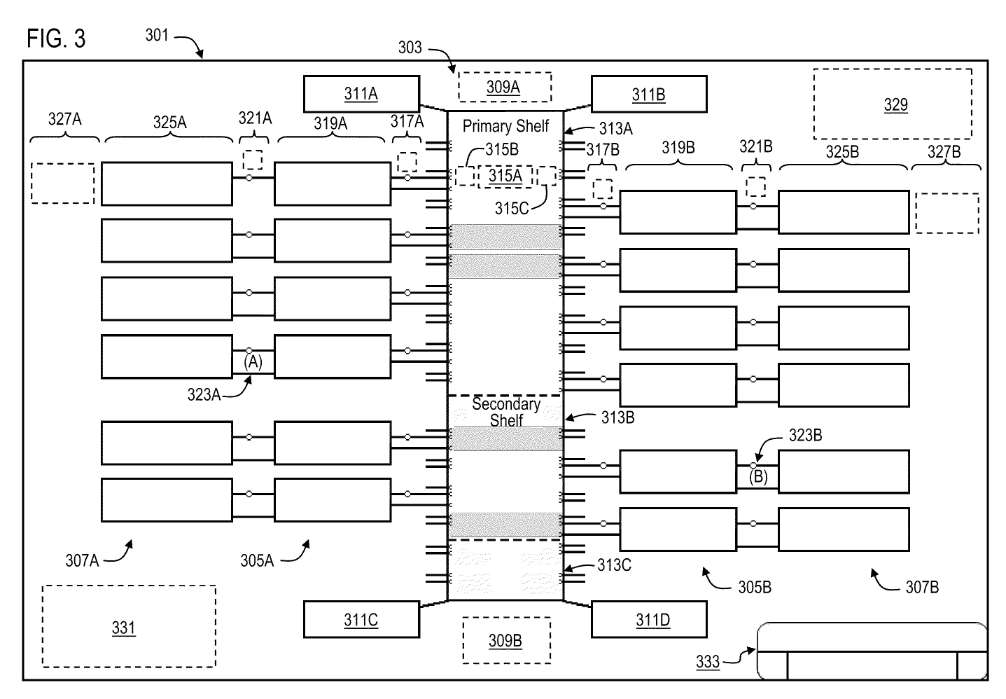

FIG. 3 is a detailed multilayered diagram 301 of infrastructure for and services provided to a customer network facility, according to one embodiment. The diagram depicted in FIG. 3 includes three different main layers of data, various interspersed data and notations in various sub-layers, as well as several areas for general notations regarding the overall facility and/or equipment.

The multilayered diagram 301 includes a first main layer 303, a pair of second layers 305A and 305B, and a pair of third layers 307A and 307B. As can be seen in FIG. 3, the second and third layers are split such that they extending outwardly from the first layer 303 in left and right directions in order to maximize the utilization of the space on the diagram. Additionally, each layer 303, 305A, 305B, 307A, and 307B includes a plurality of components/interconnections/services.

The first main layer 303 has a top area 309A that can be used to document information such as the CLLI-code for the network facility that is the subject of the diagram, and a bottom area 309B that can be used to document information regarding the particular computer cabinet/bay/shelf being diagrammed, the manufacturer and/or model of the cabinet/bay/shelf, a summary of the ports of the cabinet/bay/shelf. Also, several blocks 311A, 311B, 311C, and 311D are provided that can be used to store information regarding the contact data engineer assigned to the first main layer equipment, alarm ports, matrix capacity, software being utilized, last software upgrade, synchronization clock(s) being used, manufacturer or service provider reference number of clock(s) being used, fuses used, power board being used, manufacturer or service provider reference number of power board being used, etc.

The first main layer 303 also includes a description of the hardware provided within the cabinet/bay/shelf. The first main layer 303 includes a primary shelf 313A and description thereof, a secondary shelf 313B and description thereof, and an open area 313C. Each card provided within card slots of the cabinet are card description, card identification number, and/or service provider or manufacturer reference number in area 315A. Additionally, for ports in each card slot an area 315B is provided that can be used to document activation and inventory reference designations (e.g., assignment activation and inventory services (AAIS) designations), and for ports in each card slot an area 315C is provided that can be used to document service provider reference designations (e.g., central office equipment designations).

The information regarding each connection to a card provided in a card slot of the cabinet extends outwardly from the first layer 301 alternately in the left and right directions. Thus, the outwardly extending information includes an area 317A, 317B that describes the card's interconnection with a cabinet jack including a graphic depiction of the type of such interconnection and a listing of the length of the cable used to make the interconnection. The areas 317A and 317B are connected to boxes 319A and 319B, respectively, in the second layers 305A and 305B, respectively. The boxes 319A and 319B include information regarding the tie down information such as the cabinet jack connections. The boxes 319A and 319B are connected to areas 321A and 321B, respectively, which describe the network connections to the cabinet jacks including a graphic depiction of the type of such interconnection and a description of the type of interconnection, and can include a reference character, such as reference character “(A)” 323A and reference character “(B)” 323B, which refer to corresponding descriptions of the network connections including CLLI codes on a secondary notation sheet described in more detail below. The areas 321A and 321B are connected to boxes 325A and 325B, respectively, in the third layers 307A and 307B, respectively. The boxes 325A and 325B include information regarding the provisioning capacity of the card, network reliability provisions, percentage of capability used, etc. Additionally, areas 327A and 327B are provided outwardly from the boxes 325A and 325B, respectively. The areas 327A and 327B can include various planning and provisioning notes, testing notes, customer notes, network notes, etc.

In addition to the specific information regarding the various layers, the diagram can also include areas 329 and 331, which can be used to include various notes regarding the cabinet/bay/shelf, such as the manufacturer, model, weight, dimensions, power usage, fuse requirements, etc., or a legend that can be used to interpret various color or symbol designations used throughout the diagram. Further, a box 333 can be provided that includes an assigned name and physical location of the facility, name and contact information of a site manager, etc.

In addition to card level details, it is contemplated that the diagram can pictorially represent broader levels, such as a single function shelf—i.e., when a single service is the only option provided by the shelf. Additionally, when a shelf or bay is dedicated to one type of service, a center technical box can be represented to cover broader design views.

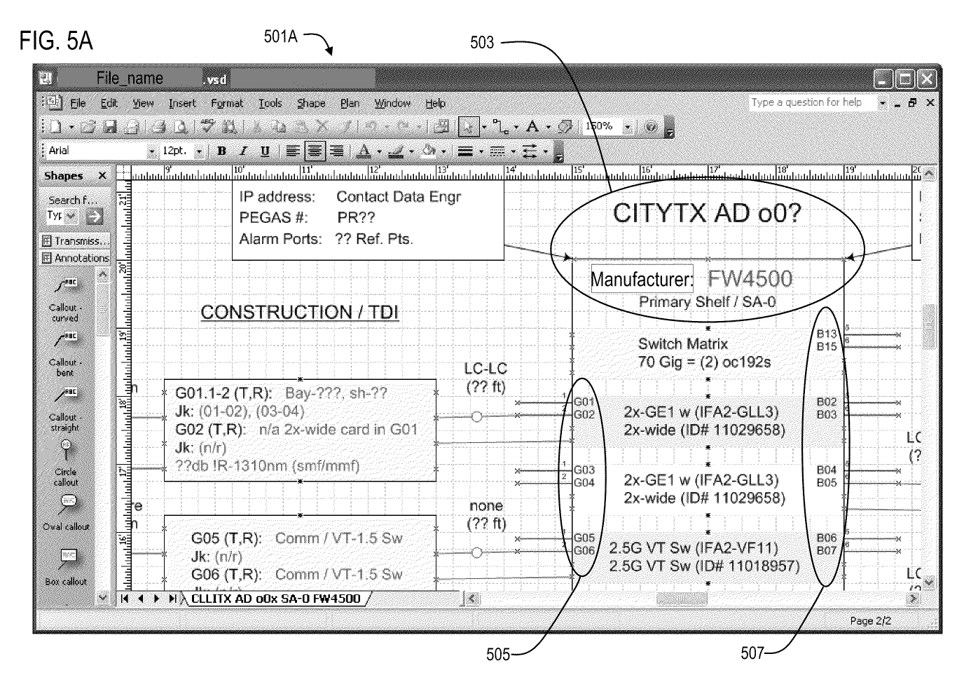

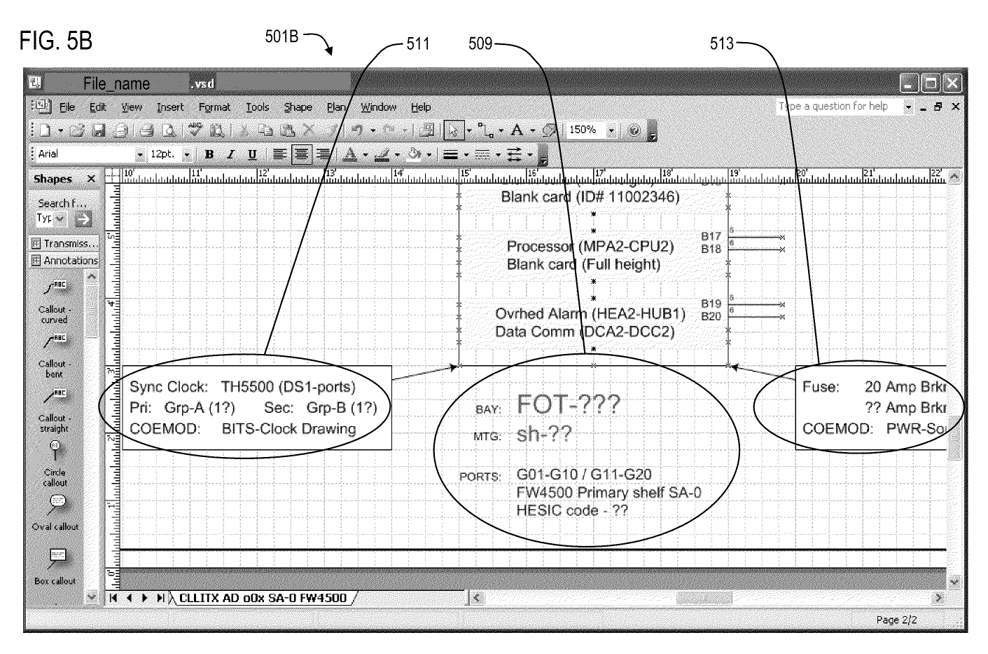

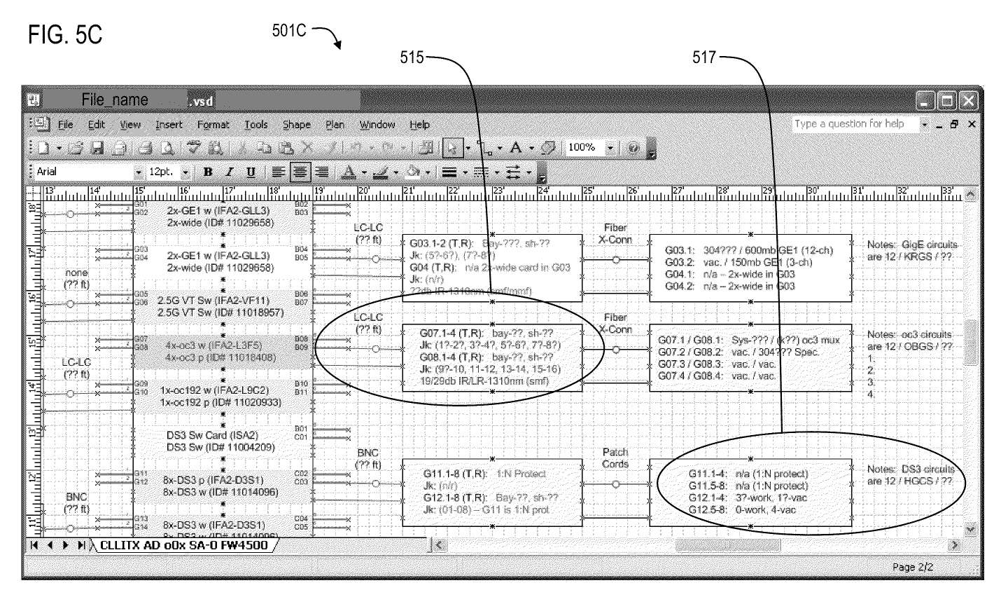

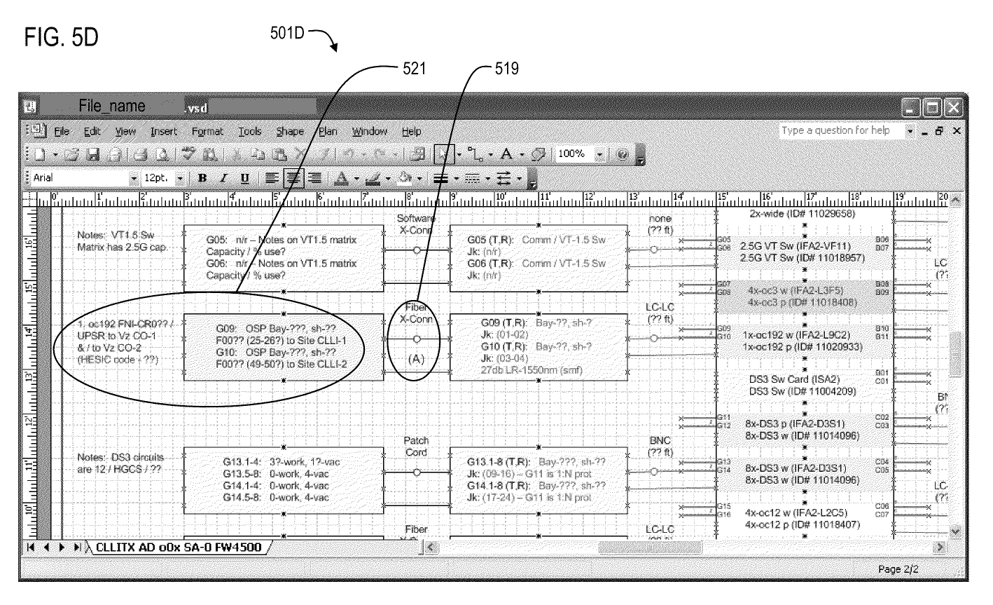

A more detailed exemplary embodiment of such a multilayered diagram can be seen in the screen-shots set forth in FIGS. 5A-5D, which are described below.

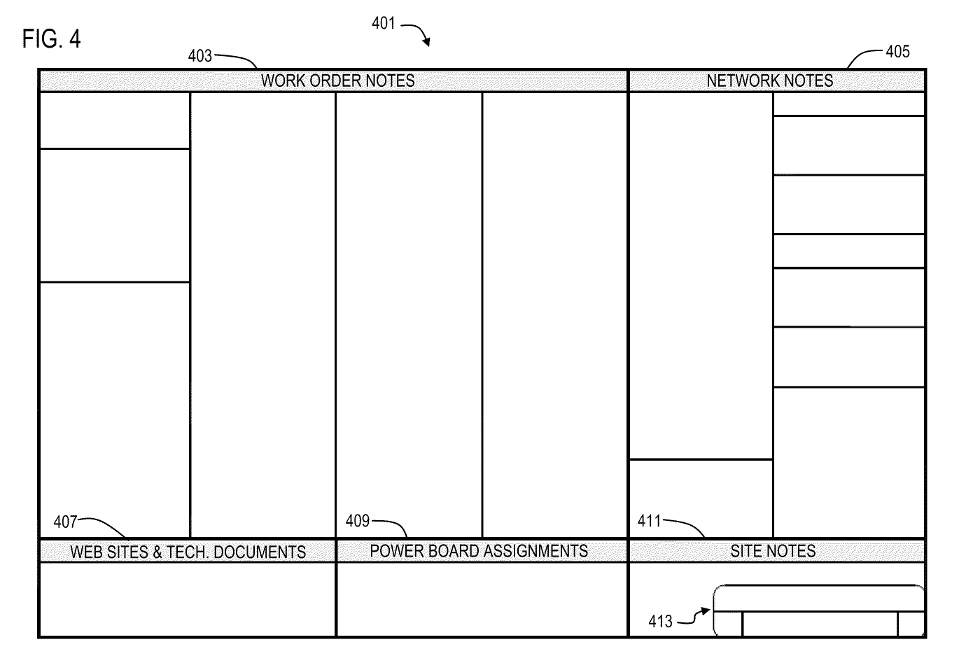

FIG. 4 is a secondary notation sheet 401 of the detailed multilayered diagram of FIG. 3, according to one embodiment. The secondary notation sheet 401 includes supplemental notes and documentation that relate to the multilayered diagram. For example, the secondary notation sheet 401 can include a work order notes section 403, a network notes section 405, a web site and technical documents section 407, a power board assignments section 409, and a site notes section 411. The secondary notes sheet 401 also includes a box 413 that includes the same information as box 333 of the multilayered diagram 301.

The work order notes section 403 can include a record of current and/or past work orders and the resolution thereof. The network notes section 405 can include detailed description of various network connections that correspond to reference characters 323A and 323B from the multilayered diagram 301. The web site and technical documents section 407 can include references to service provider technical documents/web sites, and manufacturer technical documents/web sites that correspond to the equipment or reference numbers referenced in the multilayered diagram 301. The power board assignments section 409 can include a more detailed description of the power board assignments used, and contact information for the engineer assigned to these systems. And the site notes section 411 can include detailed information regarding the facility site, such as a building contact person, a customer contact person, a sales contact person, and contact information for such individuals or departments.

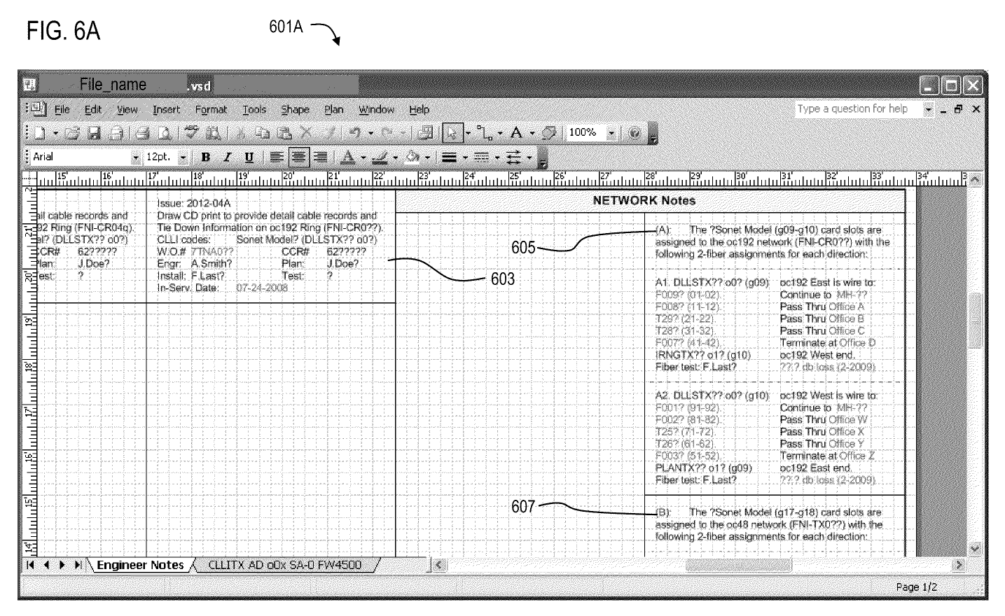

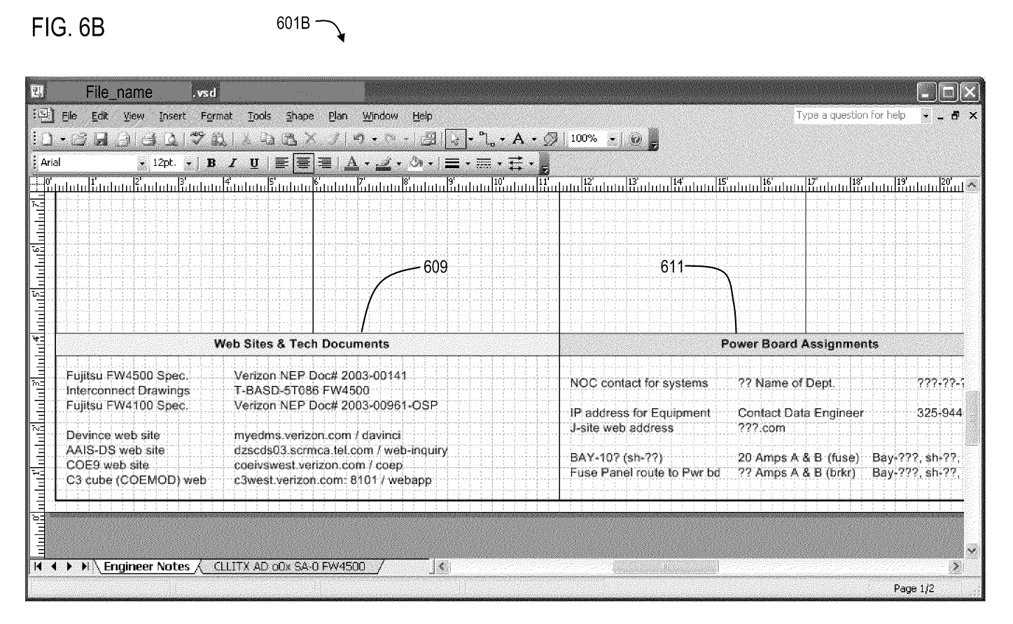

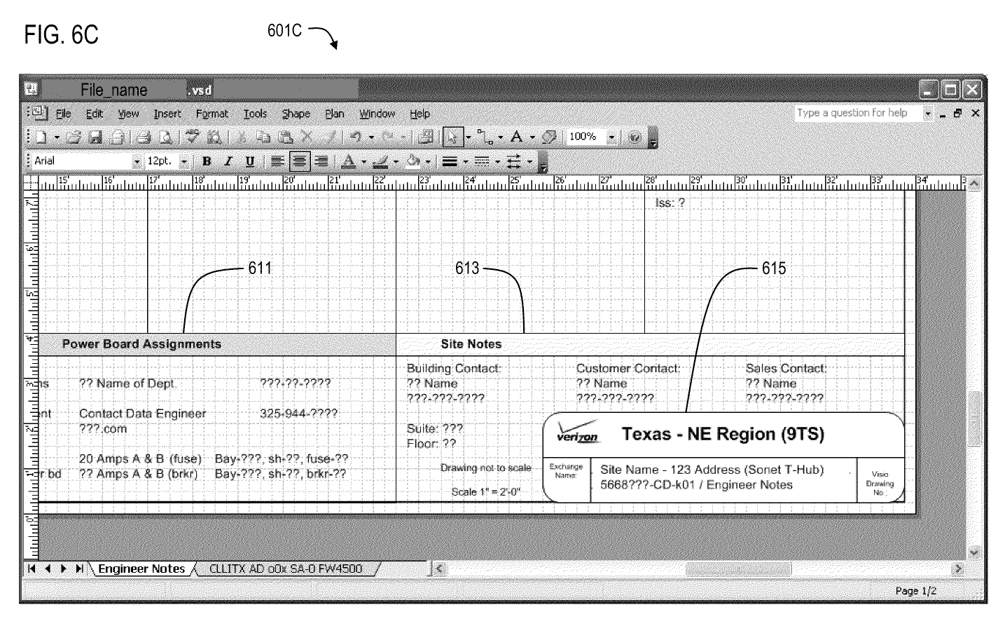

A more detailed exemplary embodiment of such a secondary notation sheet can be seen in the screen-shots set forth in FIGS. 6A-6C, which are described below.

FIGS. 5A-5D are screen-shots of a computer application used to generate a detailed multilayered diagram, including partial, enlarged views of an exemplary embodiment of a detailed multilayered diagram of infrastructure for and services provided to a customer network facility.

FIG. 5A depicts a screen-shot 501A of a computer application used to generate the detailed multilayered diagram, where an upper central portion of the diagram is enlarged. In the screen-shot 501A, an oval 503 denotes an area that includes a top area that documents the CLLI-code for the network facility that is the subject of the diagram, and an area that labels the primary shelf and describes the manufacturer and model of the primary shelf. Additionally, an oval 505 is shown that denotes exemplary activation and inventory reference designations (e.g., assignment activation and inventory services (AAIS) designations) for the card slot ports, and an oval 507 is shown that denotes exemplary service provider reference designations (e.g., central office equipment designations) for the card slot ports.

FIG. 5B depicts a screen-shot 501B of a computer application used to generate the detailed multilayered diagram, where a lower central portion of the diagram is enlarged. In the screen-shot 501B, an oval 509 denotes an area that includes a bottom area that documents the particular computer cabinet/bay/shelf being diagrammed, the manufacturer and model of the cabinet/bay/shelf, and a summary of the ports of the cabinet/bay/shelf. Also, oval 511 is shown that denotes synchronization clock information for the shelves, and an oval 513 is shown that denotes fuse information and power feeds for the cabinet/bay/shelf.

FIG. 5C depicts a screen-shot 501C of a computer application used to generate the detailed multilayered diagram, where a middle right portion of the diagram is enlarged. In the screen-shot 501C, an oval 515 denotes an area that describes the card's interconnection with a cabinet jack including a graphic depiction of the type of such interconnection and a listing of the length of the cable used to make the interconnection. Additionally, the oval 515 includes a box in the second layer that includes information regarding the tie down information such as the cabinet jack connections. Further, an oval 517 is shown that denotes a box in the third layer that includes information regarding the provisioning capacity of the card, etc. Also, the oval 517 includes notations from planning and provisioning groups.

FIG. 5D depicts a screen-shot 501D of a computer application used to generate the detailed multilayered diagram, where a middle left portion of the diagram is enlarged. In the screen-shot 501D, an oval 519 denotes an area that includes a graphic depiction of the type of such interconnection and a description of the type of interconnection, and includes a reference character “(A)” that refers to a corresponding description of the network connections including CLLI codes on a secondary notation sheet. Further, an oval 521 is shown that denotes a box in the third layer that includes information regarding the network reliability and includes circuit provisioner's basic notations to validate facility path and deliver service.

FIGS. 6A-6C are screen-shots of a computer application used to generate a detailed multilayered diagram, including partial, enlarged views of an exemplary embodiment of a secondary notation sheet of the detailed multilayered diagram of FIGS. 5A-5D

FIG. 6A depicts a screen-shot 601A of a computer application used to generate the secondary notation sheet, where an upper right portion of the sheet is enlarged. In the screen-shot 601A, notations 603 in the work order notes section are shown. Additionally, the network notes section can be used spelled out in detail the fiber path assignments. This is valuable information that can be validated/provided by the field technicians during test and turn-up. For example, the network notes section includes notation “(A)” 605 which includes a description of the network connections including CLLI codes that corresponds to the notation “(A)” from the multilayered diagram. Further, notation “(B)” 607 is shown which includes a description of the network connections including CLLI codes that corresponds to a notation “(B)” from the multilayered diagram.

FIG. 6B depicts a screen-shot 601B of a computer application used to generate the secondary notation sheet, where a lower left portion of the sheet is enlarged. In the screen-shot 601B, an exemplary web sites and technical documents section 609 is shown, and an exemplary power board assignments section 611 is shown.

FIG. 6C depicts a screen-shot 601C of a computer application used to generate the secondary notation sheet, where a lower right portion of the sheet is enlarged. In the screen-shot 601C, the exemplary power board assignments section 611 is shown, an exemplary site notes section 613 is shown, and an exemplary section 615 is shown, which includes an assigned name and physical location of the facility.

Thus, the multilayered diagram described herein is a communication tool that is designed to support engineering, construction, and provisioning groups. The multilayered diagram advantageously provides the customer with improved service and customer service.

The multilayered diagram described herein involves a three-layered diagram, where a center block is the first layer, and secondary and tertiary layers extend outward from both sides of the first layer. The multilayered diagram could alternatively include additional layers, and/or could be modified to include secondary, etc. layers extending outwardly from the first layer in more than two directions. The diagram includes not only a physical representation and description of equipment used, but also focuses on the services provided to the customer and includes cabling information to demarcation points. The diagram can cover all types of customer systems (e.g., support systems, HVAC (heating, ventilating, and air conditioning) facility systems, grounding systems, power and battery systems, clock timing systems, monitoring and alarm systems, outside plant facility systems)/revenue generating systems (e.g., digital switch/gains, specials/D4 banks, digital X-conn systems, sonnet/muxes, ROADMS (reconfigurable optical add-drop multiplexer)/DWDM (dense wavelength division multiplexing), ATM switch/data routers, video routers/FTTP (fiber to the premises) GPON (gigabit passive optical network)), and can capture detailed records for synchronization clock cable assignments, power cable assignments, and collocation connection cabling demarcations. Engineering notes on cable paths and demarcation points can be included, which are important for each site that has electronics that require a CLLI code for customer service billing.

The first layer is the center block in the diagram, which records information about the service ports available within the technology box. Details can be broken down by card service, shelf service, and bay level service. Engineering is the primary focus group for the center block of the first layer. The center block can act as a central office equipment property (COEP) database, which allows an engineer to review the card slots assigned for work/protect relations. The block can record flexible service availability, whereby the Engineer can record different card/shelf service capabilities, and shelf/bay capacity, whereby the engineer can monitor capacity exhaust and forecast equipment needs.

The second layer is the next row of blocks closest to center block. These blocks record information about the cable run list to service demarcation points. Construction is the primary focus group for the second layer. This layer can record cabling to service demarcation panels, which is critical for construction to record any changes. The second layer can also record cabling to power/sync clock and monitor points, which can act as a reference for future troubleshooting.

The third layer is the last/farthest row of blocks from center in the exemplary embodiments. These blocks record information important to assignment activation and inventory services (AAIS), which is a system used in day-to-day facilities assignment and inventory management, or another such system. The primary focus group for the third layer is the provisioning team that designs customer circuits. The third layer provides supporting documents for circuit provisioning and service technicians. The layer can also record valuable information the team has learned about the customer, or the collocation site.

A service provider network as described herein is a business that revolves around two interrelated data base systems; namely, an asset database system, and a customer service billing record/revenue system. The multilayered diagram captures information showing how these two systems work together. As a team, multiple departments can work together during the project flow to provide outstanding customer service. The multilayered diagram can provide focus to equipment records and revenue growth potential. Following a simple block diagram and applying to multiple technology, gains the advantage of learning from other groups within the service provider in ways that can win customers. Sharing knowledge between teams can develop an efficient process flow. Understanding multi-shelf and multi-bay relationships, can provide the big picture view on the systems capacity. Observing the big picture on how multi-shelves are tied together to make the total system capacity, will improve decisions on card placement and service profitability. Understanding how one group's work effects other groups, can improve each group's skills and each team's productivity. Multiple departments, working as one team to record knowledge about the customer and their service needs can improve the services provided and improve customer satisfaction. Sharing knowledge strengthens the team. Following one simple block diagram expands each of the team's ability to learn from other departments and other technology disciplines.

The multilayered diagram can also provide the blueprint for service recovery following a disaster. The multilayered diagram can act as a disaster recovery plan that will be updated in on regular, possibly daily, basis. When an emergency occurs, the multilayered diagram can provide directions to solve the problem. Essentially, the multilayer diagram can provide guidance to “reverse engineer” the technical services, audit legacy facilities, and establish directions in preparation for a disaster.

The multilayered diagram can also be used to train new employees and teach them about the technology.

The ability to record valuable knowledge discovered during day-to-day activities with customers is priceless. The multilayered diagram provides the means and opportunity to record this information. Having a structured diagram, catalogs the knowledge for others to follow and benefit from. Having a single diagram to represent multiple technical service offerings, can improve an employee's ability to learn and grow with the business. Consistency of records and project flow improves team performance and service quality.

One of ordinary skill in the art would recognize that the processes of providing a multi-layered presentation of data, described above, may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below.

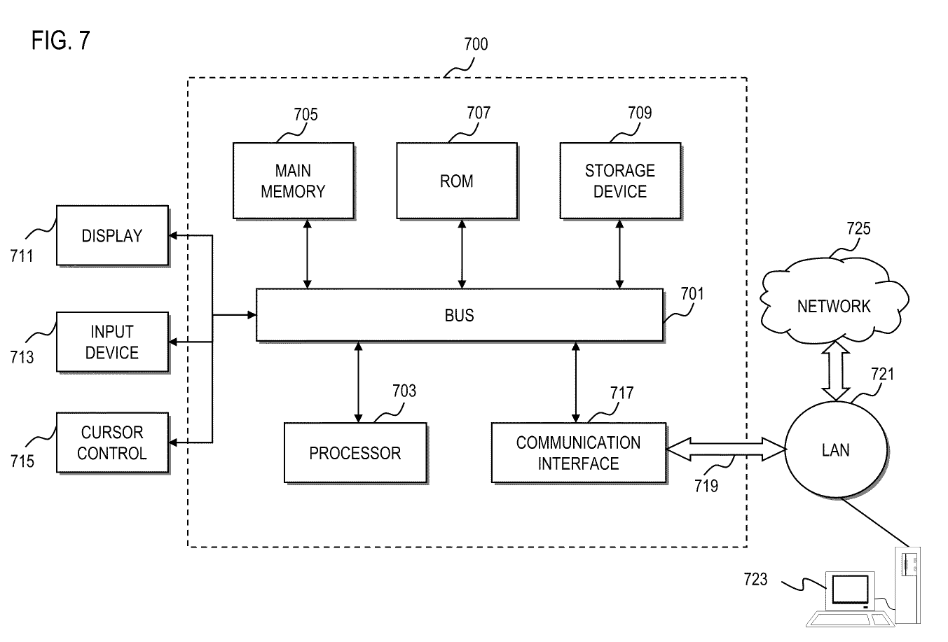

FIG. 7 illustrates a computer system 700 upon which an embodiment according to the present invention can be implemented. The computer system 700 includes a bus 701 or other communication mechanism for communicating information and a processor 703 coupled to the bus 701 for processing information. The computer system 700 also includes main memory 705, such as a random access memory (RAM) or other dynamic storage device, coupled to the bus 701 for storing information and instructions to be executed by the processor 703. Main memory 705 can also be used for storing temporary variables or other intermediate information during execution of instructions by the processor 703. The computer system 700 may further include a read only memory (ROM) 707 or other static storage device coupled to the bus 701 for storing static information and instructions for the processor 703. A storage device 709, such as a magnetic disk or optical disk, is coupled to the bus 701 for persistently storing information and instructions.

The computer system 700 may be coupled via the bus 701 to a display 711, such as a cathode ray tube (CRT), liquid crystal display, active matrix display, or plasma display, for displaying information to a computer user. An input device 713, such as a keyboard including alphanumeric and other keys, is coupled to the bus 701 for communicating information and command selections to the processor 703. Another type of user input device is a cursor control 715, such as a mouse, a trackball, or cursor direction keys, for communicating direction information and command selections to the processor 703 and for controlling cursor movement on the display 711.

According to one embodiment of the invention, the processes described herein are performed by the computer system 700, in response to the processor 703 executing an arrangement of instructions contained in main memory 705. Such instructions can be read into main memory 705 from another computer-readable medium, such as the storage device 709. Execution of the arrangement of instructions contained in main memory 705 causes the processor 703 to perform the process steps described herein. One or more processors in a multi-processing arrangement may also be employed to execute the instructions contained in main memory 705. In alternative embodiments, hard-wired circuitry may be used in place of or in combination with software instructions to implement the embodiment of the present invention. Thus, embodiments of the present invention are not limited to any specific combination of hardware circuitry and software.

The computer system 700 also includes a communication interface 717 coupled to bus 701. The communication interface 717 provides a two-way data communication coupling to a network link 719 connected to a local network 721. For example, the communication interface 717 may be a digital subscriber line (DSL) card or modem, an integrated services digital network (ISDN) card, a cable modem, a telephone modem, or any other communication interface to provide a data communication connection to a corresponding type of communication line. As another example, communication interface 717 may be a local area network (LAN) card (e.g. for Ethernet™ or an Asynchronous Transfer Model (ATM) network) to provide a data communication connection to a compatible LAN. Wireless links can also be implemented. In any such implementation, communication interface 717 sends and receives electrical, electromagnetic, or optical signals that carry digital data streams representing various types of information. Further, the communication interface 717 can include peripheral interface devices, such as a Universal Serial Bus (USB) interface, a PCMCIA (Personal Computer Memory Card International Association) interface, etc. Although a single communication interface 717 is depicted in FIG. 7, multiple communication interfaces can also be employed.

The network link 719 typically provides data communication through one or more networks to other data devices. For example, the network link 719 may provide a connection through local network 721 to a host computer 723, which has connectivity to a network 725 (e.g. a wide area network (WAN) or the global packet data communications network now commonly referred to as the “Internet”) or to data equipment operated by a service provider. The local network 721 and the network 725 both use electrical, electromagnetic, or optical signals to convey information and instructions. The signals through the various networks and the signals on the network link 719 and through the communication interface 717, which communicate digital data with the computer system 700, are exemplary forms of carrier waves bearing the information and instructions.

The computer system 700 can send messages and receive data, including program code, through the network(s), the network link 719, and the communication interface 717. In the Internet example, a server (not shown) might transmit requested code belonging to an application program for implementing an embodiment of the present invention through the network 725, the local network 721 and the communication interface 717. The processor 703 may execute the transmitted code while being received and/or store the code in the storage device 709, or other non-volatile storage for later execution. In this manner, the computer system 700 may obtain application code in the form of a carrier wave.

The term “computer-readable medium” as used herein refers to any medium that participates in providing instructions to the processor 703 for execution. Such a medium may take many forms, including but not limited to non-volatile media, volatile media, and transmission media. Non-volatile media include, for example, optical or magnetic disks, such as the storage device 709. Volatile media include dynamic memory, such as main memory 705. Transmission media include coaxial cables, copper wire and fiber optics, including the wires that comprise the bus 701. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

While the present invention has been described in connection with a number of embodiments and implementations, the present invention is not so limited but covers various obvious modifications and equivalent arrangements, which fall within the purview of the appended claims. Additionally, the features of the present invention can be combined in a numerous combinations and permutations, in which the appended claims are illustrative in nature.

What is claimed is:

1. A method comprising:
gathering information regarding assets used to provide a service to a customer over a network;
gathering information regarding services provided to the customer using the assets via the network; and
generating a diagram having multiple layers including a first layer representative of the assets, a second layer containing information regarding connections of the assets to the network, and a third layer containing information regarding provisioning of the assets to provide the services to the customer.

2. The method according to claim 1, wherein:
the first layer is a structural and descriptive representation of the assets provided in a central portion of the diagram;
the second layer extends outwardly from two opposing sides of the first layer; and
the third layer extends outwardly from two opposing sides of the second layer.

3. The method according to claim 2, wherein:
the first layer includes representations of a first asset and a second asset;
the second layer includes a first connection information extending outwardly from the first asset in a first direction, and a second connection information extending outwardly from the second asset in a second direction opposite to the first direction; and
the third layer includes a first provisioning information extending outwardly from the first connection information in the first direction, and a second provisioning information extending outwardly from the second connection information in the second direction.

4. The method according to claim 3, wherein:
the first layer includes representations of a plurality of assets;
the second layer includes connection information extending outwardly from each asset of the plurality of assets in alternating first and second directions, the second direction being opposite to the first direction; and
the third layer includes provisioning information extending outwardly from each respective connection information of the second layer in the same direction as the respective connection information.

5. The method according to claim 1, wherein:
the diagram further includes notations regarding asset connections provided between the first layer and the second layer;
the diagram further includes notations regarding network connections provided between the second layer and the third layer; and
the diagram further includes notations regarding provisioning, the customer, or the network adjacent to the third layer.

6. The method according to claim 5, further comprising:
generating a secondary notation sheet that contains information corresponding to the diagram,
wherein the notations regarding network connections in the diagram includes a reference character, and
wherein the secondary notation sheet includes a description of the network connections corresponding to the reference character.

7. The method according to claim 1, wherein the first layer contains common language location identifiers for the assets.

8. The method according to claim 1, further comprising using the diagram in a disaster recovery plan to reconstruct the assets and services.

9. The method according to claim 1, wherein the first layer is shaped to represent a structure of a computer cabinet, bay, and/or shelf.

10. The method according to claim 1, wherein the diagram further includes contact information for one or more engineers assigned to the assets and/or services, and/or contact information for one or more site representatives and/or customer representatives.

11. A method comprising:
initiating presentation of a diagram having multiple layers that are formulated using information regarding assets used to provide a service to a customer over a network, and formulated using information regarding services provided to the customer using the assets via the network,
wherein the multiple layers include a first layer representative of the assets, a second layer containing information regarding connections of the assets to the network, and a third layer containing information regarding provisioning of the assets to provide the services to the customer.

12. The method according to claim 11, wherein:
the first layer is a structural and descriptive representation of the assets provided in a central portion of the diagram;
the second layer extends outwardly from two opposing sides of the first layer; and
the third layer extends outwardly from two opposing sides of the second layer.

13. The method according to claim 12, wherein:
the first layer includes representations of a first asset and a second asset;
the second layer includes a first connection information extending outwardly from the first asset in a first direction, and a second connection information extending outwardly from the second asset in a second direction opposite to the first direction; and
the third layer includes a first provisioning information extending outwardly from the first connection information in the first direction, and a second provisioning information extending outwardly from the second connection information in the second direction.

14. The method according to claim 13, wherein:
the first layer includes representations of a plurality of assets;
the second layer includes connection information extending outwardly from each asset of the plurality of assets in alternating first and second directions, the second direction being opposite to the first direction; and
the third layer includes provisioning information extending outwardly from each respective connection information of the second layer in the same direction as the respective connection information.

15. The method according to claim 11, wherein:
the diagram further includes notations regarding asset connections provided between the first layer and the second layer;
the diagram further includes notations regarding network connections provided between the second layer and the third layer; and
the diagram further includes notations regarding provisioning, the customer, or the network adjacent to the third layer.

16. The method according to claim 15, further comprising:
providing a secondary notation sheet that contains information corresponding to the diagram,
wherein the notations regarding network connections in the diagram includes a reference character, and
wherein the secondary notation sheet includes a description of the network connections corresponding to the reference character.

17. The method according to claim 11, wherein the first layer contains common language location identifiers for the assets.

18. The method according to claim 11, wherein the first layer is shaped to represent a structure of a computer cabinet, bay, and/or shelf.

19. An apparatus comprising:
a processor configured to initiate presentation of a diagram having multiple layers that are formulated using information regarding assets used to provide a service to a customer over a network, and formulated using information regarding services provided to the customer using the assets via the network,
wherein the multiple layers include a first layer representative of the assets, a second layer containing information regarding connections of the assets to the network, and a third layer containing information regarding provisioning of the assets to provide the services to the customer.

20. The apparatus according to claim 19, wherein:
the first layer is a structural and descriptive representation of the assets provided in a central portion of the diagram;
the second layer extends outwardly from two opposing sides of the first layer; and
the third layer extends outwardly from two opposing sides of the second layer.
